(19) United States
(12) Patent Application Publication
(10) Pub. No.: US 2003/0089437 A1
(43) Pub. Date: May 15, 2003

(54) Traction device for footware

(76) Inventor: Michael Poitras, Clearwater, FL (US)

Correspondence Address: BARLOW, JOSEPHS & HOLMES, LTD., 101 DYER STREET, 5TH FLOOR, PROVIDENCE, RI, 02903, US

(21) Appl. No.: 10/292,138

(22) Filed: Nov. 12, 2002

Related U.S. Application Data
(60) Provisional application No. 60/344,430, filed on Nov. 9, 2001.

(51) Int. Cl. B60C 7/22

(52) U.S. Cl. 152/185

(57) ABSTRACT

The present invention provides a portable traction enhancement device. The present invention uses a section of conventional mesh screen material consisting of a directional weave of fiber material. The mesh material is installed in operable relation to a surface requiring enhanced traction such as a shoe sole or tire tread. Pressure exerted against the mesh causes localized melting in the icy surface allowing the strands of the mesh to engage the surface and enhance the tractional stability of the user.

### CROSS-REFERENCE TO RELATED APPLICATIONS

This application is related to and claims priority from earlier filed provisional patent application No. 60/344,430, filed Nov. 9, 2001.

### BACKGROUND OF THE INVENTION

The present invention relates to traction devices for various applications. More specifically, this invention relates to a new traction device that can be secured onto the sole of any type of standard shoe or any other operable surface such as a vehicle tire to provide increased stability and traction for the user in inclement weather conditions.

Currently, a wide variety of specific purpose shoes are produced for use in different environments or weather conditions. For example, the sole of a conventional running shoe or sneaker is relatively flat with a small amount of texture to provide superior traction on hard surfaces such as asphalt. The intended range of use of a sneaker is typically for hard surfaces with flat to slightly inclined terrain. While it provides superior performance in its range of use, a sneaker does not provide good traction in snow where the snow quickly packs into the traction pattern. In contrast, hiking shoes or boots have soles with a great deal of texture and numerous traction nubs to allow the wearer to have improved traction on loose terrain such as on dirt trails or in the open wilderness or in the snow. The bottom of the hiking shoe has improved stability and holding power on these types of terrain as it allows the loose material to be diverted around the traction nubs providing firm contact between the traction nubs and the terrain, but may be too soft or spongy to provide comfortable use on hard surfaces. This is particularly an issue when winter weather approaches.

The same is true in vehicle tire applications, while one particular tire tread design may be particularly suited for giving the user a smooth comfortable ride on dry pavement, it may not be suited for off road use or in snowy conditions. Conversely, tires with coarse tread patterns that work well off road or in slippery conditions typically create a humming sound when used on smooth pavement.

In general, most people must travel to and from their homes and workplaces during the winter weather. In these cases, a person must use one type of shoe to get traction in the snow and then change into a different pair of shoes for around the office or their home. The reason for this is as stated above, typically the shoes that provide good performance on solid dry surfaces do not perform well in low traction applications. The converse is also true; those shoes that have high traction do not provide comfort to the wearer for use on flat dry surfaces. Further complication the issue is the fact that the soles of both types of shoe are typically made of a similar rubber material. This is particularly a problem due to the fact the when conditions become extremely none of the previously mentioned shoes are helpful in providing good traction for the user.

The prior art offers several devices that are attached to the bottom of conventional shoes in an attempt to offer improved traction in icy conditions. One prior art attempt provides for an array of metal spikes in a rubber sole plate to be strapped to the bottom of the shoe. While this device provides effective and superior traction in icy conditions, if it is left on the shoe and worn indoors, it will cause severe damage to the floor finishes. In addition, if the user is wearing the device and encounters only periodic patches of ice in addition to cleared pavement or concrete, the hard substrates may damage the traction device. Another prior device employs a grid of springs crossing beneath the sole of the shoe. This device functions much the same as the spikes, while the potential damage to floor finishes is slightly reduced it is not eliminated as the springs are coarse. In addition, the springs can be damaged if worn on hard concrete surfaces because the wound core is hollow and can be crushed. In addition, both of these devices are bulky and must be carried by the user when removed from the shoe.

In the case of vehicle tires, the situation is similar, as manufactures make studded tires and large tread pattern tires that the user can have installed for winter driving. As an alternative, the user can have chain traction devices that they apply over the tires for temporary use. However, once the immediate need has been satisfied, the tires must again be changed to smooth tires for use on dry pavement.

There is therefore a need for a unique traction assembly that can provide enhanced traction for the user without being particularly bulky or requiring specialized sole elements for use.

### BRIEF SUMMARY OF THE INVENTION

In this regard, the present invention provides for a novel portable traction device. The device is particularly suited for use with rubber devices that require enhanced traction. In particular, the present invention is particularly suited for use in both the footwear and rubber tire field. In this disclosure, use with conventional shoes will be described, but the manner of use is the same in application to rubber tires, therefore, while the structure will be described in conjunction with shoes, it should be clear that an alternate embodiment for use with tires is herein disclosed and provided.

The present invention uses a section of conventional mesh screen material consisting of a directional weave of fiber material. For example, an appropriate material for use in the present invention is a conventional woven aluminum screen mesh as is used in window screens. The present invention however is not limited to this material, as a fiberglass screen material may also be employed. In addition, a custom weave of fiber may also be employed having more than simply a bidirectional fiber pattern. Other materials that may be suitable include carbon fiber, Kevlar, fiberglass and metallic wires. Further, patterns that include more than a two directional weave, such as a three directional triangle for example are also anticipated for use herein. Finally, the present invention is not limited to woven meshes as welded meshes can also be incorporated into the present invention.

The screen material is cut roughly to a shape that is appropriate for application to the bottom of the wearers shoe and applied using standard tacks. An alternate form of the invention provides for a frame, roughly the size of the sole of the shoe, in which the section of mesh material is retained. Straps are connected to the frame that are wrapped over the top of the shoe and secured so as to retain the frame in an operative position beneath the sole of the wearer's shoe. Another alternate form provides for the frame to be a rubber material with clips at the front and back of the frame that allow the frame to be stretched over the bottom of the sole of the shoe and grasp the shoe at the front and rear edges of the sole, retaining the device in place against the bottom of the shoe. Finally, the present invention may include integral retention clips at the front and back of the screen for incorporation into a specialty shoe sole that includes mating formations for receiving the retention clips.

The traction device of the present invention provides superior performance in icy conditions. The coarse surface of the woven screen material grips the slippery surface of ice allowing the user to walk in a normal fashion without the fear of slipping and falling. In addition, the texture of the screen, although coarse, is not harsh enough to damage finished surfaces of interior floors in the event a wearer forgets to remove the device from their shoes before entering a building. Finally, the present invention is compact and has a flexible, thin profile that allows the device to be folded when removed from the wearer's shoes. Since the device is compact and has no sharp spikes or protrusions, it can be placed in the users pocket when not in use providing for easy and convenient storage.

In similar fashion, the mesh of the present invention may be cut to a size that is particularly applicable for attachment to a vehicle tire. The strip of mesh is placed around the outer surface of the tire over the rubber tread and retained in place with a series of hooks and retention bands on the interior and exterior face of the circumference of the tire. In this manner, the mesh is retained in a similar fashion as prior art traction chains are retained.

Accordingly, one of the objects of the present invention is the provision of a convenient, lightweight, low cost traction system for improving the traction of shoe soles or tire treads. Another object of the present invention is the provision of a traction system that enhances frictional stability while reducing the potential of damage should the device be worn over finished surfaces. Yet a further object of the present invention is the provision of a universal traction system that provides enhanced traction on ice while further being convenient, removable and easily portable.

Other objects, features and advantages of the invention shall become apparent as the description thereof proceeds when considered in connection with the accompanying detailed description and claims appended hereto. BRIEF DESCRIPTION OF THE DRAWINGS

### In the drawings which illustrate the best mode presently contemplated for carrying out the present invention:

FIG. 1 is a bottom perspective view of a first embodiment the traction device of the present invention installed on the sole of a shoe;

FIG. 2 is a top perspective view thereof with a frame and retention clips;

FIG. 3 is an alternate embodiment of the mesh pattern used therein; and

FIG. 4 is a perspective view an alternate embodiment of the traction device of the present invention installed on a vehicle tire.

### DETAILED DESCRIPTION OF THE INVENTION

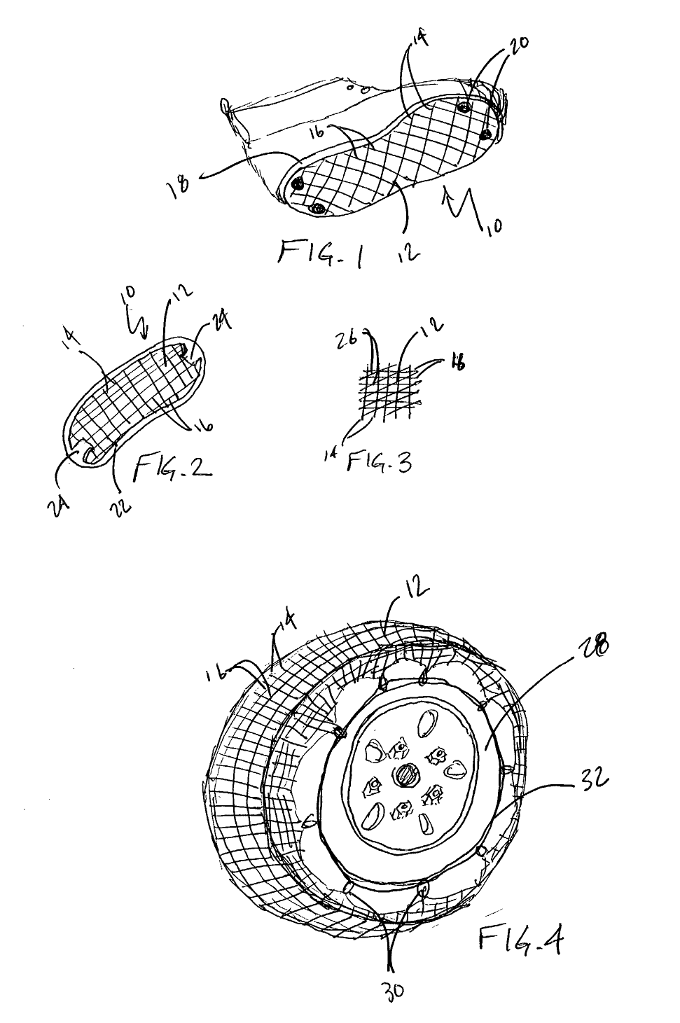

Referring now to the drawings, the improved traction device of the present invention is illustrated and generally indicated at 10 in FIGS. 1 and 2. The device of the present invention provides for the installation of a mesh screen 12 material in any application where enhanced traction applications are indicated. While the present invention is illustrated in this description and in the drawings for use with the bottoms of shoes and over the treads of tires, these two embodiments are intended for the purpose of illustration only and are not intended to be limiting to the scope of the present invention as the disclosure provided herein allows the use of the present invention in all applications requiring enhanced traction.

Turning to FIG. 1 the present invention is provided as a mesh screen material 12. The screen 12 is illustrated here as a conventional aluminum window screen material. Typically, as can be seen, the screen is formed as a two directional woven mesh with one set of woven fibers 14 running in one linear direction and a second set of linear fibers 16 running perpendicular to the first set 14. The screen material 12 may be formed from a traditional woven aluminum material or from other fibers as are well known in the art and may include stainless steel, Kevlar, fiberglass or steel. Further, while the screen 12 provided herein is described as being woven, it may also be formed monolithically as a welded wire mesh, an expanded mesh or a die stamped mesh. The particular goal of the present invention is simply to provide a traction layer that enhances traction by providing a layer that enhances the friction against slippery surfaces while not being particularly abrasive against other surfaces such as finished floors.

Referring again to FIG. 1 the traction enhancement device 10 of the present invention is shown attached to the bottom of a shoe sole 18. The mesh material 12 is cut to the approximate size of the shoe sole 18 and is shown retained in place by tacks 20 that penetrate slightly into the sole 18 of the shoe. In this manner, the traction device 10 is retained in operable relation to the bottom sole 18 of the shoe. As the wearer of the shoe walks on slippery surfaces that are coated with ice, the pressure of the sole 18 of the shoe is transferred into the individual wires 14, 16 in the mesh 12. This pressure is then transferred into the ice causing the ice directly beneath the wires 14, 16 to instantaneously melt allowing each wire 14, 16 to form a tiny channel in the ice. Once the array of wires 14, 16 in the mesh 12 form a corresponding array of channels in the ice, the wires 14, 16 engage the channels, preventing the user's foot from slipping. Each time the user takes another step this process is instantaneously repeated allowing the user to walk safely at a normal pace.

Referring now to FIG. 2 the mesh 12 of the present invention is shown in connection with a retention frame 22. The frame 22 provides for the mesh 12 to be stretched on the lower surface thereof. The user places the frame 22 over the sole 18 of their shoe. As can be seen, clips 24 at the front and rear of the frame 22 frictionally retain the frame 22 onto the shoe placing the screen 12 in operable relation to the bottom of the shoe sole and eliminating the need for placing tacks 20 into the sole 18 of the shoe.

FIG. 3 shows an alternate mesh pattern 12 wherein three sets of strands 14, 16, 26 are used to form a triangular mesh pattern 12. Further, any variety of mesh patterns may be used and fall within the scope of the present invention.

Finally, FIG. 4 shows the traction assembly 10 of the present invention in conjunction with a vehicle tire 28. A strip of mesh 12 is placed around the outer circumference of the tire 28. Hooks 30 are placed into the edges of the mesh 12 on its peripheral edges. A resilient band 32 is passed through the hooks 30 on the inner and outer edges of the tire 28 to draw the mesh 12 taught across the traction surface of the tire 28 and retain it in operable position on the tread surface of the tire 28. Once in place, as described above, pressure between the tire 28 and the icy surface cause increased pressure on the fibers 14, 16 of the mesh 12 causing them locally to melt into the surface of the ice creating enhanced traction.

It can therefore be seen that the present invention provides a compact, lightweight, low cost traction assebly 10 that can be quickly and easily installed and removed as desired by the user. Further, when removed it can easily be stored for future use. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A traction enhancing system comprising:
at least one sheet of conformable mesh fabric adapted to be removably applied in operable relation adjacent to the operable surface of a traction device.

2. A traction enhancing system comprising:
a pair of shoes, each shoe having a respective sole, each sole having a contact surface; and
a pair of conformable mesh fabric sheets adapted to be applied in operable relation adjacent to said contact surfaces of said soles.

3. A traction enhancing system comprising:
at least one strip of conformable mesh fabric adapted to be applied in operable relation adjacent to the outer tread surface of a vehicle tire.
